(19) United States
(12) Patent Application Publication
(10) Pub. No.: US 2008/0040464 A1
(43) Pub. Date: Feb. 14, 2008

(54) DUAL PHASED MANUFACTURING DATA PROCESSING METHODS AND SYSTEMS

(75) Inventor: Tong-Lung Chia, Hsinchu County (TW)

Correspondence Address: THOMAS, KAYDEN, HORSTEMEYER & RISLEY LLP, 600 GALLERIA PARKWAY, 15TH FLOOR, ATLANTA, GA, 30339, US

(73) Assignee: TAIWAN SEMICONDUCTOR MANUFACTURING CO., LTD., Hsin-Chu (TW)

(21) Appl. No.: 11/463,618

(22) Filed: Aug. 10, 2006

(51) Int. Cl. G06F 15/173

(52) U.S. Cl. 709/223

(57) ABSTRACT

Computer-implemented dual phased manufacturing data processing methods and systems. A data analysis phase is established. Manufacturing data is collected from various sources and categorized as at least two predetermined category data types. Data of one of the two data types is analyzed and actions thereof generated in accordance with the analysis result. Actions of the other type of data are also generated.

### BACKGROUND

The present invention relates to manufacturing data management methods, and in particular to computer-implemented dual phase manufacturing data processing methods and systems.

In integrated circuit (IC) related manufacturing foundries, such as semiconductor product foundries, communication between customers and manufacturers is important. Service systems are generally provided to customers for communication therebetween. The service systems may provide online functions, such as mask file viewing, manufacturing plan updating, or order changing such that data integrated thereby are utilized during manufacture.

Service systems are maintained by supporting engineers according to information obtained from customers and detection systems. The detection systems can be, via hardware or software, connected to the service systems and manufacturing tools, such as detection programs in manufacturing tools, data filtering rules in databases, or security control modules in service systems.

Manufacturing data can be generated by customers, service systems, detection systems, and engineers, and is generally classified as urgent and non-urgent. Urgent data requires immediate processing and operators take suitable action thereto. Non-urgent data is conventionally collected and stored, and may be integrated and analyzed for reference only when support operators seek to maintain service systems or assist customers.

FIG. 1 is a diagram of a conventional single phased manufacturing data processing system. Service systems 100 are provided by manufacturers to customers 102. The customers 102 may access the service systems 100 through networks 104, such as the Internet. Detection systems 106 are connected to the service systems 100, customers 102, and manufacturing tools 108. After the detection systems 106 collected and compiled manufacturing data 110 from various sources, the manufacturing data 110 is categorized as urgent data 112 or non-urgent data 114. Support operators 116 may take necessary action correspondingly to respond to data urgency.

When a customer 102 encounters problems in service systems 100, the customer 102 may communicate with service personnel 118. The service personnel 118 reports the problems back to the support operators 116. Here, the support operators 116 integrate and analyze the non-urgent data for problem solving of service systems 100.

Non-urgent data may comprise usable manufacturing information, and when integrated and analyzed systematically, services for customers, including security control, can be upgraded. For example, unusual secure events for customers can be identified beforehand, service potential issues can be improved, and optimal operations for customers can be provided.

Therefore, a dual phased manufacturing data processing method is desirable.

### SUMMARY

An embodiment of the invention provides computer-implemented two-phase manufacturing data processing methods. The methods comprise data collection and data processing. Manufacturing data is collected from various sources, such as customers, engineers, services systems, and detection systems, and classified as urgent data and non-urgent data. The urgent data requires immediate processing and necessary action is generated correspondingly to data urgency. The non-urgent data is then analyzed. Corresponding action is generated according to the analysis result.

### BRIEF DESCRIPTION OF THE DRAWINGS

The invention can be more fully understood by reading the subsequent detailed description and examples with references made to the accompanying drawings, wherein:

FIG. 1 is a diagram of a conventional single phased manufacturing data processing system.

FIG. 2 is a flowchart of an embodiment of a computer-implemented dual phased manufacturing data processing method.

FIG. 3 is a diagram of an embodiment of a dual phased manufacturing data processing system.

FIG. 4 is a diagram of an exemplary implementation of a dual phased manufacturing data processing system.

### DESCRIPTION

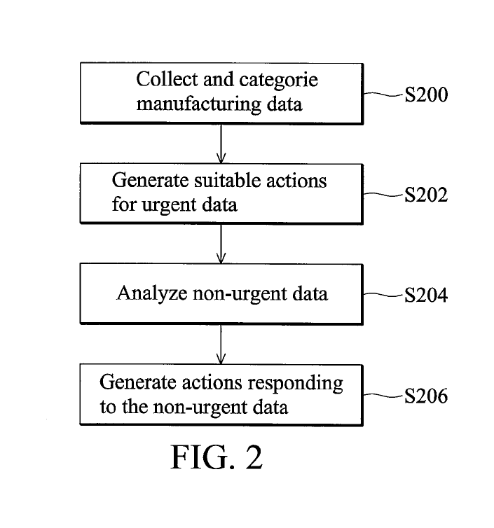

FIG. 2 is a flowchart of an embodiment of a computer-implemented dual phased manufacturing data processing method. Manufacturing data is collected and classified as urgent data and non-urgent data (Step S200). The manufacturing data may be collected from various sources, such as customers, engineers, detection systems of manufacturing tools, and service systems for the customers. The manufacturing data may be collected through networks, such as the Internet. The non-urgent data may comprise warning, status, and log data. Warning data indicate states which are unusual but not urgent. Status data implies the current statuses of systems, such as service systems or detection systems. Log data comprises entrance records for system users, such as customers, operators, or other systems. The urgent data from various sources indicates that the corresponding manufacturing situations require to be handled immediately.

Suitable actions for the urgent data, such as terminating one manufacturing process or debugging an on-line controller, are generated (step S202). The non-urgent data is then analyzed (step S204). The analysis comprises data integration, data recalculation, historical data analysis, urgent data reference, and data conversion.

Actions responding to the non-urgent data are generated according to the analysis results (step S206). The actions comprise notification of customers and/or operators, updating databases of the detection systems, and establishing data filtering rules in the service systems.

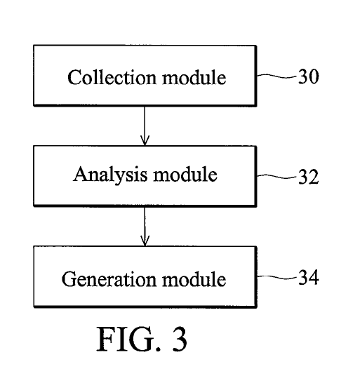

FIG. 3 is a diagram of an embodiment of a dual phased manufacturing data processing system. The dual phased manufacturing data processing system comprises a collection module 30, an analysis module 32, and a generation module 34.

The collection module 30 collects manufacturing data from various sources, such as customer systems, support operation systems, detection systems of manufacturing tools, and service systems for the customers. The manufacturing data is classified as urgent data and non-urgent data. The collection module 30 may collect the manufacturing data through networks, such as the Internet. Here, the non-urgent data may comprise warning, status, and log data.

The analysis module 32 analyzes the non-urgent data by data integration, data recalculation, historical data analysis, urgent data reference, and data conversion.

The generation module 34 generates actions to the non-urgent data according to the analysis result. The generation module 34 also generates actions of the urgent data. The actions comprise notification of customers and/or operators, updating databases of the detection systems, and establishing data filtering rules in the service systems.

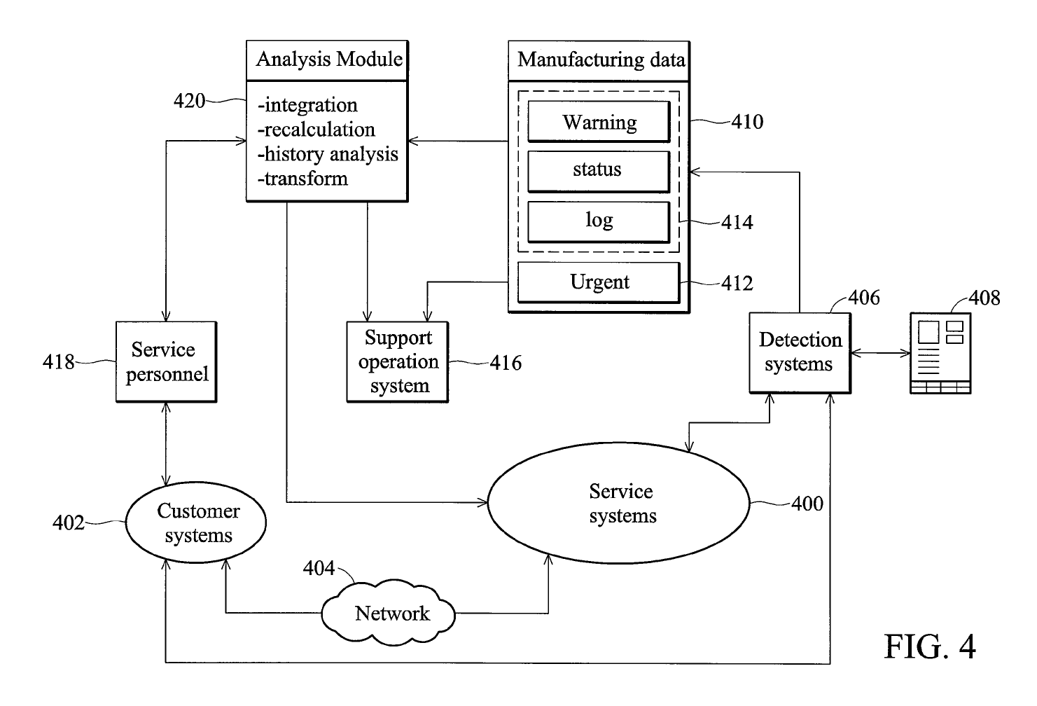

FIG. 4 is a diagram of an exemplary implementation of a dual phased manufacturing data processing system. Service systems 400 are provided by manufacturers to customer systems 402. The customer systems 402 may access the service systems 400 through networks 404, such as the Internet. Detection systems 406, connected to the service systems 400, customer systems 402, and manufacturing tools 408, are coupled to receive data from all resources and operated to generate manufacturing data 410. After the detection systems 406 collected and compiled manufacturing data from various sources, the manufacturing data is categorized as urgent data 412 and non-urgent data 414. The manufacturing data 410 is processed by an analysis module 420, which conducts operations and analyses on manufacturing data 410 to generate analysis results. The data processing may comprise data integration, data recalculation, historical data analysis, urgent data reference, and data conversion. The analysis results and corresponding reactions are sent to a support operation system 416.

The operator attending to the support operation system 416 may provide instructions to the support operation system to take action corresponding to the urgent data 412 to respond to data urgency and take action of the non-urgent data 414 to maintain the service systems 400. If the analysis result shows optimal operations for the customers 402, corresponding information may be sent to service personnel 418. The service personnel 418 can recommend or notify the customers 402 prior to problems occurring.

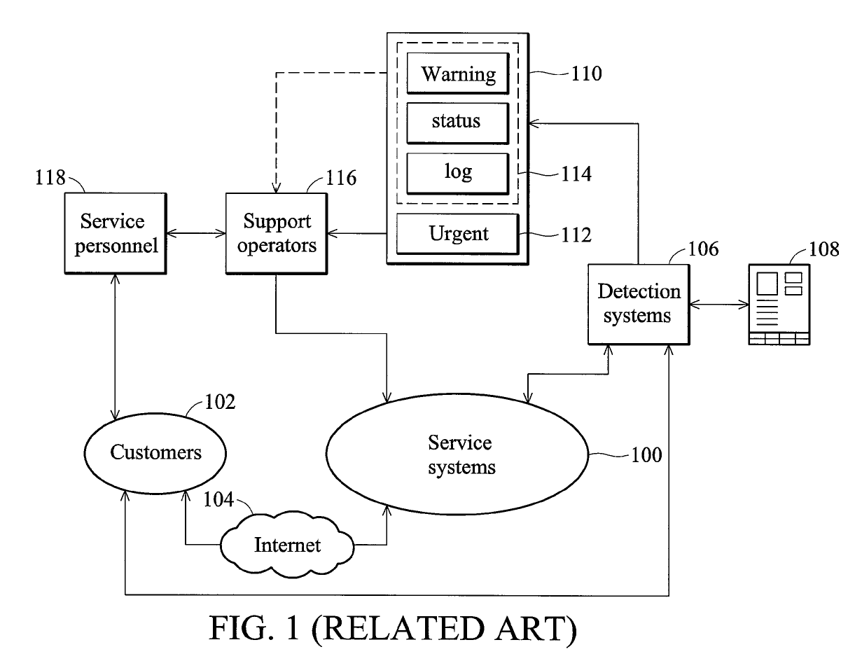

An analysis module 420 appears in FIG. 4, unlike FIG. 1. The analysis module 420 analyzes manufacturing data and generates corresponding reactions. The analysis result can be utilized in the maintenance of the service systems or provide recommendations to the customers, improving service quality significantly.

While the invention has been described by way of example and in terms of preferred embodiment, it is to be understood that the invention is not limited thereto. Those skilled in the technology can still make various alterations and modifications without departing from the scope and spirit of this invention. Therefore, the scope of the present invention shall be defined and protected by the following claims and their equivalents.

What is claimed is:

1. A computer-implemented dual phased manufacturing data processing method, comprising:
collecting manufacturing data, wherein the manufacturing data is categorized into at least two predetermined category data types;
analyzing data of one of the two data types; and
generating actions to the analyzed data in accordance with the analysis result.

2. The computer-implemented dual phased manufacturing data processing method of claim 1, further generating actions to the other type of data.

3. The computer-implemented dual phased manufacturing data processing method of claim 1, wherein the type of data being analyzed comprises warning, status, and log data.

4. The computer-implemented dual phased manufacturing data processing method of claim 1, wherein the manufacturing data is collected from customer systems, a support operation system, detection systems of manufacturing tools, and service systems for the customer systems.

5. The computer-implemented dual phased manufacturing data processing method of claim 4, wherein the reactions comprise informing the customer systems and/or the support operation system, updating databases of the detection systems, and establishing data filtering rules in the service systems.

6. The computer-implemented dual phased manufacturing data processing method of claim 1, wherein the manufacturing data are collected through networks.

7. The computer-implemented dual phased manufacturing data processing method of claim 1, wherein the analysis comprises data integration, data recalculation, historical data analysis, urgent data reference, and data conversion.

8. A dual phased manufacturing data processing system, comprising:
a collection module, collecting manufacturing data, wherein the manufacturing data is categorized into at least two predetermined category data types;
an analysis module, coupled to the collection module, analyzing the data of one of the two data types; and
a generation module, coupled to the analysis module, generating actions to the analyzed data in accordance with the analysis result.

9. The dual phased manufacturing data processing system of claim 8, wherein the generation module further generates actions to the other type of data.

10. The dual phased manufacturing data processing system of claim 8, wherein the type of data being analyzed comprises warning, status, and log data.

11. The dual phased manufacturing data processing system of claim 8, wherein the collection module collects manufacturing data from customer systems, a support operation system, detection systems of manufacturing tools, and service systems for the customers.

12. The dual phased manufacturing data processing system of claim 11, wherein the actions comprise informing the customer systems and/or the support operation system, updating databases of the detection systems, and establishing data filtering rules in the service systems.

13. The dual phased manufacturing data processing system of claim 8, wherein the collection module collects the manufacturing data through networks.

14. The dual phased manufacturing data processing system of claim 8, wherein the analysis module analyzes the data by data integration, data recalculation, historical data analysis, urgent data reference, and data conversion.

15. An integrated circuit product manufactured by a computer-implemented dual phased manufacturing data processing method, the method comprising:
collecting manufacturing data, wherein the manufacturing data is categorized into at least two predetermined category data types;
analyzing data of one of the two data types; and
generating actions to the analyzed data in accordance with the analysis result.

16. The integrated circuit product of claim 15, wherein the method further generates actions to the other type of data.

17. The integrated circuit product of claim 15, wherein the type of data being analyzed comprises warning, status, and log data.

18. The integrated circuit product of claim 15, wherein the manufacturing data is collected from customer systems, a support operation system, detection systems of manufacturing tools, and service systems for the customers.

19. The integrated circuit product of claim 18, wherein the actions comprise informing the customer systems and/or the support operation system, updating databases of the detection systems, and establishing data filtering rules in the service systems.

20. The integrated circuit product of claim 15, wherein the manufacturing data is collected through networks.

21. The integrated circuit product of claim 15, wherein the analysis comprises data integration, data recalculation, historical data analysis, urgent data reference, and data conversion.
